(19) United States
(12) Patent Application Publication
(10) Pub. No.: US 2020/0326688 A1
(43) Pub. Date: Oct. 15, 2020

(54) FACILITY MANAGEMENT SYSTEM

(71) Applicant: JTEKT CORPORATION, Osaka-shi (JP)

(72) Inventors: Tomonari OGI, Obu-shi (JP); Sakon MURAYAMA, Kariya-shi (JP); Keisuke IWAMOTO, Kariya-shi (JP)

(73) Assignee: JTEKT CORPORATION, Osaka-shi (JP)

(21) Appl. No.: 16/830,898

(22) Filed: Mar. 26, 2020

(30) Foreign Application Priority Data
Apr. 9, 2019 (JP) 2019-074106
Apr. 9, 2019 (JP) 2019-074107

(51) Int. Cl. G05B 19/418; G06F 13/42

(52) U.S. Cl. CPC G05B 19/4183; G05B 19/41865; G06F 13/4282; G05B 19/4185; G05B 19/4188

(57) ABSTRACT

A facility management system capable of suppressing an increase in cost and man-hours, and capable of transmitting sensor information on a facility item sensing sensor to an outside from the facility is provided. A facility management system includes: a communication unit provided with a communication processing part capable of communicating sensing signals sensed by sensors over the wireless, and a facility status management apparatus provided with a management communication part capable of communicating with the communication processing part over the wireless. The communication unit includes a communication unit terminal attachable/detachable to/from a first light sensing sensor terminal of light sensing sensor units and attachable/detachable to/from a facility item sensing sensor terminal of a facility item sensing sensor unit.

### CROSS REFERENCE TO RELATED APPLICATIONS

This application claims priority based on Japanese Patent Application No. 2019-074106 filed on Apr. 9, 2019, and Japanese Patent Application No. 2019-074107 filed on Apr. 9, 2019, the entire contents of which are incorporated by reference herein.

### BACKGROUND OF THE INVENTION

### 1. Field of the Invention

The present invention relates to a facility management system.

### 2. Description of the Related Art

In a facility management system, by configuring the system to be able to transmit a facility status to an outside from the facility, an operator and an administrator can easily perceive a facility status, and thus can achieve an improvement of production efficiency. However, in order to configure the system to be able to transmit the facility status to the outside from the facility, alteration of an existing control device such as alteration of software (ladder circuit) of a programmable logic controller (PLC) in the facility, and addition of a new control device into an existing control panel such as addition of relay components to fetch an input signal to the PLC may be required. Therefore, costs and man-hours are increased.

JP2004-6291A discloses an apparatus including an light sensing sensor provided on an indicator lamp capable of displaying the facility status and capable of transmitting the facility status from the facility to the outside. In other words, the apparatus senses light of the indicator lamp by the light sensing sensor and transmits a light sensing signal indicating the facility status to the outside from the facility via a wireless communication apparatus. With this apparatus, alteration of the existing control device and addition of a new control device to the existing control panel are no longer necessary. Therefore, an increase in costs and man-hours can be suppressed.

### SUMMARY OF THE INVENTION

In general, the facility includes facility item sensing sensors such as a proximity sensor, a distance sensor, and a pressure sensor disposed therein, so that sensor information can be transmitted to the outside from the facility to enable an operator and an administrator to easily perceive the sensor information, which leads to improvement in production efficiency. However, the apparatus described in JP2004-6291A has a configuration in which the light sensing sensor and the communication device are incorporated in advance in the indicator lamp. Therefore, in order to transmit the sensor information to the outside from the facility in the facility management system, alteration of the existing control device and addition of a new control device into the existing control panel is required. Consequently, costs and man-hours are increased.

In view of such circumstances, it is an object of the present invention is to provide a facility management system capable of suppressing an increase in costs and man-hours, and capable of transmitting sensor information from a facility item sensing sensor to the outside from the facility.

### Solution to Problem

A facility management system according to the present invention includes: a communication unit including a main body part disposed on an indicator lamp capable of displaying a facility status, a communication unit terminal attachable/detachable to/from a terminal in a sensor unit, and a communication processing part capable of being communicably connected with a sensor in the sensor unit and capable of communicating a sensing signal from the sensor over the wireless; and a facility status management apparatus including a management communication part capable of communicating with the communication processing part over the wireless and a management information display displaying information on a sensing signal from the sensor communicating via the management communication part.

The sensor unit includes a light sensing sensor unit including a light sensing sensor configured to sense light from the indicator lamp and a first light sensing sensor terminal connected with the light sensing sensor, and the sensor unit also includes a facility item sensing sensor unit including a facility item sensing sensor configured to sense items relating to the facility and a facility item sensing sensor terminal connected with the facility item sensing sensor. The communication unit terminal is attachable/detachable to/from the first light sensing sensor terminal and is attachable/detachable to/from the facility item sensing sensor terminal. In this configuration, since the communication unit terminal of the communication unit is capable of being communicably connected with the light sensing sensor and is also capable of being communicably connected with the facility item sensing sensor, an increase in installation cost of the facility item sensing sensor can be suppressed.

### BRIEF DESCRIPTION OF THE DRAWINGS

FIG. 1 is a schematic drawing of a facility management system according to an embodiment of the present invention.

FIG. 2A is a drawing illustrating details of a communication unit of the facility management system disposed on an indicator lamp of the facility and a light sensing sensor unit connected with the communication unit.

FIG. 2B is a drawing of FIG. 2A rotated by 90 degrees about a vertical axis of the indicator lamp.

FIG. 3A is a drawing illustrating details of the light sensing sensor unit.

FIG. 3B is a drawing illustrating a state in which three light sensing sensor units are connected.

FIG. 4 is a drawing illustrating a facility item sensing sensor unit configured to connect a facility item sensing sensor with the communication unit.

FIG. 5A is a flowchart for explaining an operation of a first half of the facility management system.

FIG. 5B is a flowchart for explaining the operation of a second half of the facility management system.

FIG. 6 is a drawing illustrating a facility selection screen displayed on a mobile information display of a mobile terminal unit.

FIG. 7 is a drawing illustrating a facility status selection screen relating to the facility displayed on the mobile information display of the mobile terminal unit.

FIG. 8 is a drawing illustrating integrated information relating to the facility displayed on a management information display of a facility status management apparatus (the mobile information display of the mobile terminal unit).

FIG. 9 is a drawing illustrating a planned production quantity and an actual production quantity displayed on the management information display of the facility status management apparatus (the mobile information display of the mobile terminal unit).

FIG. 10 is a drawing illustrating a planned operating rate and an actual operating rate displayed on the management information display of the facility status management apparatus (the mobile information display of the mobile terminal unit).

FIG. 11 is a drawing illustrating a planned operating time and an actual operating time displayed on the management information display of the facility status management apparatus (the mobile information display of the mobile terminal unit).

### DESCRIPTION OF EMBODIMENTS

### 1. Configuration of Facility Management System

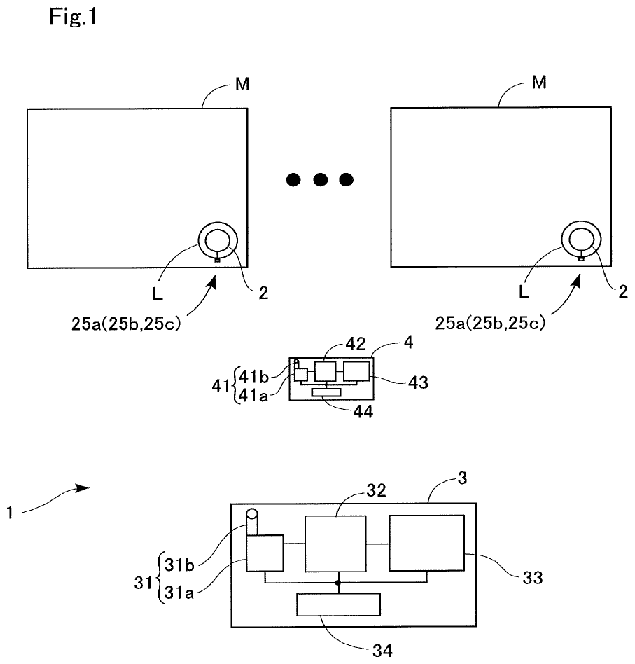

Referring now to the drawings, a facility management system of an embodiment of the present invention will be described. As illustrated in FIG. 1, a facility management system 1 is a system configured to manage a plurality of facilities M. The facility management system 1 includes light sensing sensor units 25a, 25b and 25c configured to detect light of an indicator lamp L on each facility M, a communication unit 2 capable of communicating light sensing signals from the light sensing sensor units 25a, 25b and 25c over the wireless, a facility status management apparatus 3 configured to communicate with each communication unit 2 over the wireless to manage a facility status of each facility M at the same time, and a portable mobile terminal unit 4 communicating with the facility status management apparatus 3 over the wireless so as to allow an operator to confirm the facility status.

The facility M is, for example, a machining apparatus capable of cutting or grinding a workpiece. The communication unit 2 is detachably attached to the indicator lamp L provided on an upper part of each facility M and indicates the facility status by emitting light. The facility status management apparatus 3 is installed at a position separated from the plurality of facilities M. The mobile terminal unit 4 includes a smartphone and a tablet PC, which can be carried by the operator or the like.

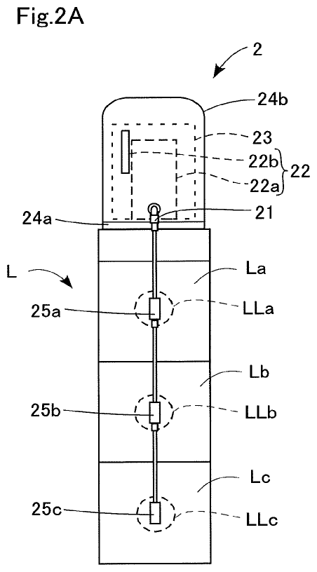

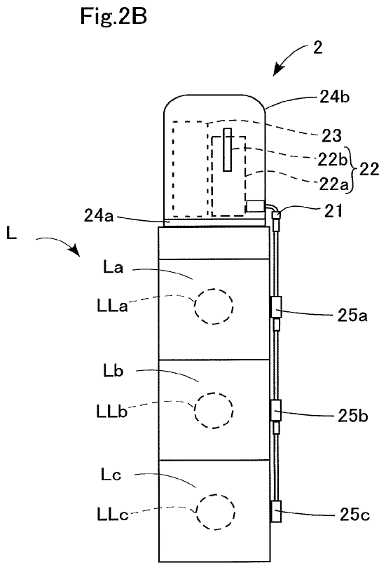

As illustrated in FIG. 2A and FIG. 2B, the indicator lamp L is a general lamp with hollow cylindrical translucent plastic cases La, Lb and Lc stacked in 3 stages, and light sources LLa, LLb and LLc such as LEDs are disposed inside the plastic cases La and Lb and Lc, respectively.

The plastic cases La, Lb and Lc are colored in the order of green, yellow and red from an upmost layer, for example, and are lit or flicker in green, yellow and red by light emission from the light sources LLa, LLb and LLc. The indicator lamp L has a pattern in which three colors are independently lit, a pattern in which two colors are simultaneously lit, a pattern in which three colors are simultaneously lit, a pattern in which three colors are simultaneously lit out, and a pattern in which three colors independently flicker.

The facility statuses meant by the respective patterns can be freely set on an installation side. For example, when the three colors are independently lit, setting may be made as follows. Lit in green means that the facility status of the facility M is normal (during production), lit in yellow means that the facility status of the facility M is during setup, and lit in red means that the facility status of the facility M is abnormal (failure), and flickering in green means that the facility status of the facility M is completed in production (one product). Other patterns can also be set as desired.

As illustrated in FIG. 2A and FIG. 2B, the communication unit 2 includes a communication unit terminal 21, a communication processing part 22, and a detection power source unit 23. The communication processing part 22, the detection power source unit 23 and the like are disposed in a disk-shaped main body part 24a and covered with a cylindrical cover 24b. The communication unit terminal 21 is provided so as to protrude outward from a lower part of an outer periphery of the cover 24b.

The communication unit 2 is placed on an upper portion of the indicator lamp L and is fixed as necessary. As will be described later in detail, the light sensing sensor units 25a, 25b and 25c are detachably connected with the communication unit terminal 21 of the communication unit 2 by a serial bus and are suspended therefrom. The light sensing sensor units 25a, 25b and 25c are disposed on peripheral surfaces of the plastic cases La, Lb and Lc capable of detecting light from the light sources LLa, LLb and LLc of the indicator lamp L, respectively.

The light sensing sensor units 25a, 25b and 25c respectively sense on and off and flickering of the light sources LLa, LLb and LLc of the indicator lamp L. Since the light sensing sensor units 25a, 25b and 25c can also sense flickering, the communication unit 2 can detect various facility statuses.

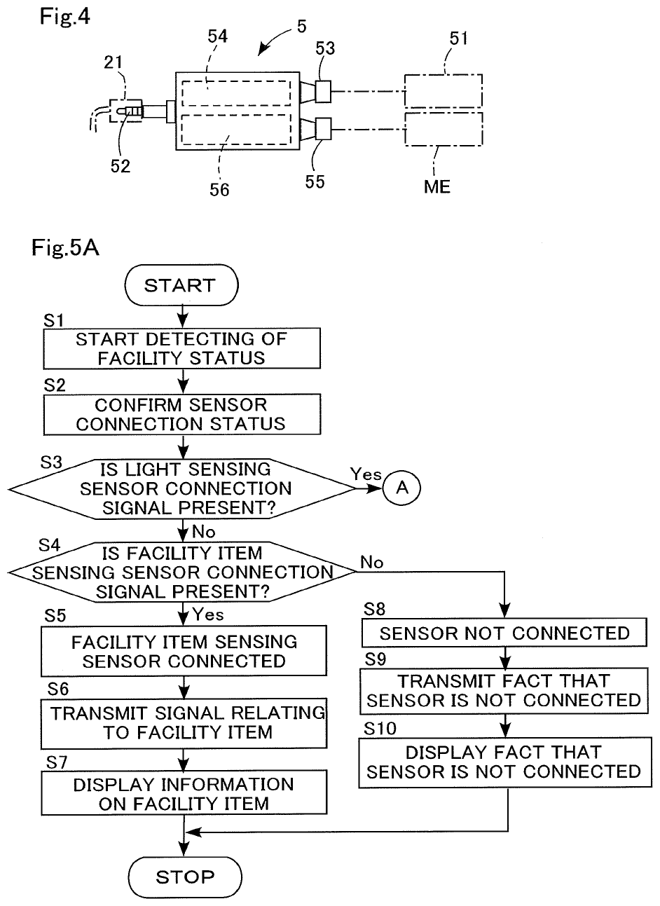

As will be described in details later, in place of the light sensing sensor units 25a, 25b and 25c, a facility item sensing sensor 51 (see FIG. 4) configured to sense the item relating to the facility M is detachably connectable with the communication unit terminal 21 via a facility item sensing sensor unit 5 (see FIG. 4) by the serial bus. Accordingly, an increase in installation cost of the facility item sensing sensor 51 can be suppressed.

The communication processing part 22 includes a wireless module 22a and an integrated antenna 22b. The wireless module 22a communicates signals relating to the light sensing sensor units 25a, 25b and 25c, and a signal relating to the facility item sensing sensor 51 or the like with the facility status management apparatus 3 over the wireless.

Here, since the communication unit 2 is installed in the facility M, the facility M may be located remotely from the facility status management apparatus 3 in a factory in which a plurality of facilities M are installed. Further, the communication processing part 22 of the remote communication unit 2 may not be able to smoothly communicate with the facility status management apparatus 3 over the wireless.

Therefore, communication between the communication processing part 22 of one communication unit 2 and the facility status management apparatus 3 can be performed by relaying the communication processing part 22 of another communication unit 2. This relay is performed by activating only the communication processing part 22 of the communication unit 2 required, and the communication processing part 22 is automatically made to sleep after the relay. Accordingly, power consumption can be reduced.

The detection power source unit 23 is a dry battery or a rechargeable battery and supplies a drive current used for operating the light sensing sensor units 25a, 25b and 25c and the wireless module 22a. The communication unit 2, being battery-driven, does not need a construction work in the facility M, and thus can easily be retro-fitted.

Here, the light sensing sensor units 25a, 25b and 25c connectable with the communication unit terminal 21 of the communication unit 2 are digital sensors. Since a drive current is always required for an analog sensor and, in the first place, the current consumption is large (for example, 100 μA), maintenance of the detection power source unit 23 becomes complicated. However, since the digital sensor requires the drive current only at the time of sensing, and, in the first place, the consumption current is small (for example, 1.8 μA at the time of sensing and 0.3 μA at the time of non-sensing), maintenance of the detection power source unit 23 becomes easy.

The light sensing sensor units 25a, 25b and 25c are photodiodes configured to sense light fluxes (light amount (lm (lumen)) passing though per unit time or illuminance (light flux (lx (lux)) incident per unit surface area (1 m²)) from the respective light sources LLa, LLb and LLc, and output on/off signals (light sensing signals).

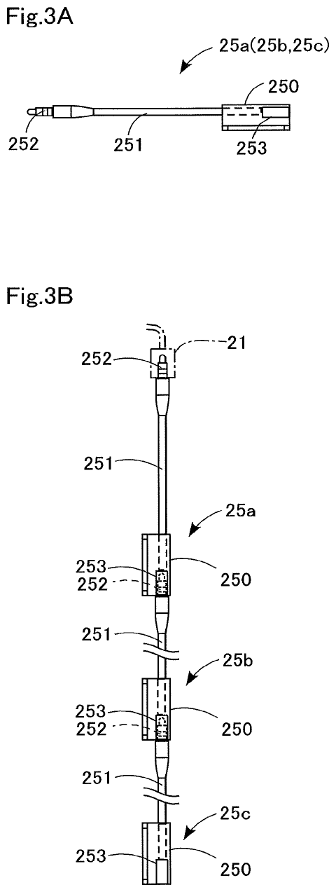

As illustrated in FIG. 3A, in the light sensing sensor unit 25a, a first light sensing sensor terminal 252 is connected with a communication cable 251 provided on one end of a light sensing sensor 250 by a serious bus, and a second light sensing sensor terminal 253 provided on the other end of the light sensing sensor 250 is connected with the communication cable 251 by a serious bus. Other light sensing sensor units 25b and 25c have the same structure.

As illustrated in FIG. 3B, the first light sensing sensor terminal 252 of the light sensing sensor unit 25a is detachably connected with the communication unit terminal 21 by a serious bus. Accordingly, even when the indicator lamp L is changed, only replacing with a new light sensing sensor unit corresponding to the changed indicator lamp is needed. Therefore, a simple installation is possible, and an increase in installation cost can be suppressed.

Then, the first light sensing sensor terminal 252 of the light sensing sensor unit 25b is connected with the second light sensing sensor terminal 253 of the light sensing sensor unit 25a by a serious bus, and the first light sensing sensor terminal 252 of the light sensing sensor unit 25c is connected with the second light sensing sensor terminal 253 of the light sensing sensor unit 25b by a serious bus.

That is, the three light sensing sensor units 25a, 25b and 25c are connected in a daisy chain mode. Accordingly, the number of wirings from the light sensing sensor units 25a, 25b and 25c can be reduced. Further, a first light sensing sensor terminal of still another light sensing sensor unit is connectable with the second light sensing sensor terminal 253 of the light sensing sensor unit 25c by a serious bus, and in the same manner, a plurality of light sensing sensor units are connectable with the same by a serious bus. Accordingly, it can cope with the change in mode of the indicator lamp, for example, a multiple indicator lamp including four or more lamps while suppressing an increase in costs and man-hours.

The facility item sensing sensor 51 configured to sense the item relating to the facility M connectable with the communication unit terminal 21 of the communication unit 2 is a sensor configured to output on/off signals (facility item sensing signals) or output signals other than the on/off signals (facility item detecting signals). Specifically, the sensor may include, for example, a photoelectric sensor, a distance sensor, a pressure sensor, a proximity switch, a humidity sensor, a CO₂ sensor, and an image processing camera. By connecting the facility item sensing sensor 51, the following processing can be performed by the facility status management apparatus 3.

For example, the facility status management apparatus 3 can measure the number of workpieces to be produced by reading variation in amount of light shielded by the workpieces conveyed on a conveyor with the photoelectric sensor. Further, by reading variations in distance to the workpieces conveyed on the conveyor with the distance sensor, a plurality of types of the workpieces may be determined. Further, by installing the pressure sensor in an air piping, measurement of variations in pressure the air is achieved.

As illustrated in FIG. 4, the facility item sensing sensor unit 5 includes a facility item sensing sensor terminal 52, a sensor connector 53, a serial converter 54, a power source connector 55, and a power supply unit 56. The facility item sensing sensor terminal 52 is detachably connected with the communication unit terminal 21 of the communication unit 2 by a serial bus. Accordingly, the facility item sensing sensor 51 can share the communication unit terminal 21 with the light sensing sensor units 25a, 25b and 25c.

The facility item sensing sensor 51 is connected with the sensor connector 53. The serial converter 54 converts the facility item sensing signal from the facility item sensing sensor 51 to allow serial communication and communicates with the communication unit terminal 21 of the communication unit 2 via the facility item sensing sensor terminal 52. The serial converter 54 is provided with a pull-up resistor because the transistor (photocoupler) is used and is configured to reduce power consumption by turning the pull-up resistor on only when necessary and turning off when unnecessary.

The power source connector 55 is connected with an AC adapter connected with a power source ME of a control panel of the facility M, a clamp type AC current sensor (2 wire type), an NPN (3 wire type) sensor, a PNP (3 wire type) sensor, and so forth. By connecting the clamp-type AC current sensor, whether or not the facility M is operating can be determined. The power supply unit 56 supplies a drive current from the power source connector 55 to the serial converter 54 and the facility item sensing sensor 51.

The communication unit 2 described thus far has one communication unit terminal 21, and the light sensing sensor units 25a, 25b and 25c and the facility item sensing sensor 51 (the facility item sensing sensor unit 5) are connected with the communication unit terminal 21 in an alternative way. However, a configuration is also applicable in which a plurality of communication unit terminals 21 are provided, and the light sensing sensor units 25a, 25b and 25c and the facility item sensing sensor 51 (the facility item sensing sensor unit 5) are connected at the same time. Accordingly, the facility M can be managed finely in the facility status management apparatus 3.

As illustrated in FIG. 1, the facility status management apparatus 3 includes a management communication part 31, a management control unit 32, a management information display 33, a management power source unit 34, and the like. The management communication part 31 includes a wireless module 31a, and an integrated antenna 31b. The wireless module 31a communicates signals relating to the light sensing sensor units 25a, 25b and 25c, signals relating to the facility item sensing sensor and the like between the communication unit 2 and the mobile terminal unit 4 over the wireless.

The management control unit 32 processes the signals relating to the light sensing sensor units 25a, 25b and 25c, the signals relating to the facility item sensing sensor and the like and displays the processed information on the management information display 33. In addition, in order to allocate communication timing to the communication unit 2, the management control unit 32 transmits time information to all the communication units 2 provided with the same timer. The display example of the management information display 33 will be described later. The management power source unit 34 supplies a drive current used for operating the wireless module 31a, the management control unit 32, and the management information display 33.

As illustrated in FIG. 1, the mobile terminal unit 4 includes a mobile communication part 41, a mobile control unit 42, a mobile information display 43, and a mobile power source unit 44. The mobile communication part 41 includes a wireless module 41a and an integrated antenna 42b. The wireless module 41a communicates signals relating to the light sensing sensor units 25a, 25b and 25c, signals relating to the facility item sensing sensor, and the like with the facility status management apparatus 3 over the wireless.

The mobile control unit 42 displays information obtained by processing the signals relating to the light sensing sensor units 25a, 25b and 25c received from the facility status management apparatus 3, the signal relating to the facility item sensing sensor, and the like on the mobile information display 43. The display example of the mobile information display 43 will be described later. The mobile power source unit 44 includes a rechargeable battery and supplies a drive current to operate the wireless module 41 a, the mobile control unit 42, and the mobile information display 43.

Here, the operator may not know the abnormality content and the maintenance procedure although the fact that the facility status is abnormal is recognized by the indicator lamp. In such a case, the operator needs to move from the facility to the management apparatus to confirm the facility. JP2018-92499A describes a system including a mobile terminal capable of communicating with a management apparatus. Since abnormality contents and maintenance procedure are displayed on the mobile terminal, the operator does not have to go to the management apparatus from the facility to confirm the facility and can cope with abnormality in the facility. However, in this management apparatus, it is not possible to confirm whether the operator's correspondence is appropriate or not. According to the facility management system 1 of the present embodiment, the administrator can collate the sensed information on the communication unit 2 with the visual information on the mobile terminal unit 4, can reliably perceive the facility status of the facility M, and can manage the correspondence to the operator.

### 2. Operation of Facility Management System

Next, the operation of the facility management system 1 will be described with reference to the drawings. Here, the communication unit 2 may start detection upon reception of an inquiry about the facility status from the facility status management apparatus 3 and may start detection when the detection power source unit 23 of the communication unit 2 is turned on.

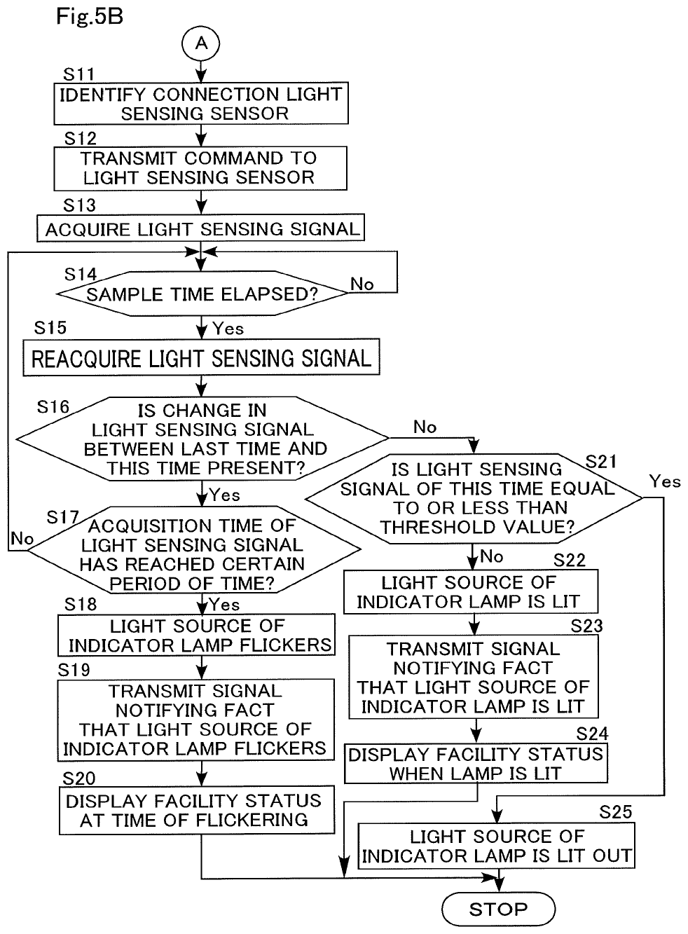

The communication processing part 22 of the communication unit 2 starts detection of the facility status in response to an inquiry about the facility status received from the facility status management apparatus 3, or when the detection power source unit 23 is turned on (Step S1 in FIG. 5A). The communication processing part 22 transmits a sensor connection status confirmation signal via the communication unit terminal 21 (Step S2 in FIG. 5A). Accordingly, an operation for detecting the facility status can be reliably performed.

The communication processing part 22 determines whether or not a light sensing sensor connection signal is returned for the sensor connection status confirmation signal (Step S3 in FIG. 5A) and, if the light sensing sensor connection signal is not returned, determines whether or not a facility item sensing sensor connection signal has been returned (Step S4 in FIG. 5A). If the facility item sensing sensor connection signal is returned, it is determined that the facility item sensing sensor 51 is connected (Step S5 in FIG. 5A).

Then, the communication processing part 22 transmits a signal relating to the sensed facility item to the facility status management apparatus 3 over the wireless (Step S6 in FIG. 5A). The management control unit 32 of the facility status management apparatus 3 displays information on the facility items on the management information display 33 based on the signal relating to the facility items and received by the management communication part 31 (Step S7 in FIG. 5A) and terminates the processing.

On the other hand, in Step S4, if the facility item sensing sensor connection signal is not returned, the communication processing part 22 determines that the light sensing sensor units 25a, 25b and 25c and the facility item sensing sensor 51 are not connected (Step S8 in FIG. 5A). Then, the communication processing part 22 transmits a signal indicating that the sensor is not connected to the facility status management apparatus 3 over the wireless (Step S9 in FIG. 5A). The management control unit 32 of the facility status management apparatus 3 displays the fact received by the management communication part 31 that the sensor is not connected on the management information display 33 (Step S10 in FIG. 5A) and terminates the processing.

On the other hand, in Step S3, if the light sensing sensor connection signal is returned, the communication processing part 22 identifies the connected light sensing sensor unit 25a, 25b or 25c based on the returned light sensing sensor connection signal (Step S11 in FIG. 5B). In other words, since the light sensing sensor connection signals from the light sensing sensor units 25a, 25b and 25c are returned with a time lag therebetween (a signal “1” if connected and a signal “0” if not connected), a connected one among the light sensing sensor units 25a, 25b and 25c can be identified.

In this example, since the light sensing sensor units 25a, 25b and 25c are connected, the wireless module 22a transmits commands for operating the light sensing sensor units 25a, 25b and 25c to addresses for identifying the light sensing sensor units 25a, 25b and 25c to the light sensing sensor units 25a, 25b and 25c via the communication unit terminal 21 (Step S12 in FIG. 5B). Accordingly, the light sensing signal of the predetermined light sensing sensor unit can be reliably acquired. In the following description, for the sake of convenience, a case where the light sensing sensor unit 25a senses a change in the green light source LLa will be described.

The communication processing part 22 acquires a light sensing signal (a signal “1” if light is lit, and a signal “0” if light is lit out) from the light sensing sensor unit 25a via the communication unit terminal 21 (Step S13 in FIG. 5B). Then, the communication processing part 22 determines whether or not a predetermined sample time has elapsed (Step S14 in FIG. 5B), and if a predetermined sample time has elapsed, reacquires a light sensing signal from the light sensing sensor unit 25a via the communication unit terminal 21 (Step S15 in FIG. 5B).

The sample time is set to 250 ρsec, for example, in a mode of sensing flickering and lit/lit out as in the present example. In a mode of sensing only lit and lit off without sensing flickering, the sample time is set, for example, to 1 sec. This mode switching is enabled by a mode switching signal from the facility status management apparatus 3.

Then, the communication processing part 22 compares a light sensing signal acquired last time with a light sensing signal acquired this time and determines whether or not the change of the value of the light sensing signal crosses a preset threshold value, that is, whether or not these signals are a light sensing signal having a value exceeding a threshold value and a light sensing signal having a value equal to or less than the threshold value (Step S16 in FIG. 5B). This threshold value is set to prevent erroneous sensing due to manufacturing variations among the light sources LLa, and to prevent an erroneous sensing due to sunlight or the like, and the set value can be changed by a threshold value setting change signal from the facility status management apparatus 3.

When the communication processing part 22 determines that the value of the light sensing signal acquired this time is changed from the value of the light sensing signal acquired last time crossing the threshold value, the communication processing part 22 then determines whether or not an acquisition time of the light sensing signal for determining the presence or absence of flickering reaches a certain period of time (Step S17 in FIG. 5B). When the acquisition time of the light sensing signal does not reach the certain period of time, the communication processing part 22 returns to Step S14 and repeats the above-described processing.

In contrast, when the acquisition time of the light sensing signal has reached or exceeded a certain period of time, the light sensing signal having a value exceeding the threshold value and the light sensing signal having a value equal to or less than the threshold value are present within the certain period of time, so that it is determined that the light source LLa of the indicator lamp L is flickering (Step S18 in FIG. 5B). According to this determination method, since only the transmission of the on/off light sensing signal is required, the power consumption of the sensor can be suppressed. Then, the communication processing part 22 transmits a signal notifying the fact that the green light source LLa of the indicator lamp L on the facility M is flickering to the facility status management apparatus 3 over the wireless (Step S19 in FIG. 5B).

The management control unit 32 of the facility status management apparatus 3 displays the fact that the facility status is “production completed” (one product) in the facility M based on the signal received by the management communication part 31 notifying the fact that the green light source LLa of the indicator lamp L on the facility M is flickering on the management information display 33 (Step S20 in FIG. 5B), and terminates the processing. Accordingly, the administrator can recognize that the facility status is the “production completed” (one product) in the facility M.

On the other hand, in Step S16, when the communication processing part 22 determines that the change between the light sensing signal acquired last time and the light sensing signal acquired this time does not cross the threshold value, the communication processing part 22 determines whether or not the light sensing signal acquired this time has a value equal to or less than the threshold value (Step S21 in FIG. 5B).

When the communication processing part 22 determines that the light sensing signal acquired this time exceeds the threshold value, it is determined that the light source LLa of the indicator lamp L is lit (Step S22 in FIG. 5B). Then, the communication processing part 22 transmits a signal notifying the fact that the light source LLa of the indicator lamp L on the facility M is lit in green to the facility status management apparatus 3 over the wireless (Step S23 in FIG. 5B).

The management control unit 32 of the facility status management apparatus 3 displays the fact that the facility status is normal (during production) in the facility M based on the signal received by the management communication part 31 notifying the fact that the light source LLa of the indicator lamp L on the facility M is lit in green on the management information display 33 (Step S24 in FIG. 5B), and terminates the processing. Accordingly, the administrator can recognize that the facility M is normal (during production).

On the other hand, in Step S21, when the communication processing part 22 determines that the light sensing signal acquired this time is equal to or less than the threshold value, it is determined that the light source LLa of the indicator lamp L is lit out (Step S25 in FIG. 5B), and terminates the processing.

### 3. Display Example of Display Device

Next, a display example of the management information display 33 and the mobile information display 43 will be described with reference to the drawings. A first display example is a display that can be confirmed by the facility status management apparatus 3 and the mobile information display 43 as to whether or not the facility status of the facility M sensed by the light sensing sensor units 25a, 25b and 25c in the communication unit 2 is correct. The first display example will be described below.

It is assumed that the facilities M from No. 1 to No. 50 are installed in a factory. For example, when the light sensing sensor unit 25b senses that the indicator lamp L is lit in red, the communication unit 2 of the facility M No. 1 transmits a signal notifying that the indicator lamp L on the facility M No. 1 is lit in red to the facility status management apparatus 3 over the wireless.

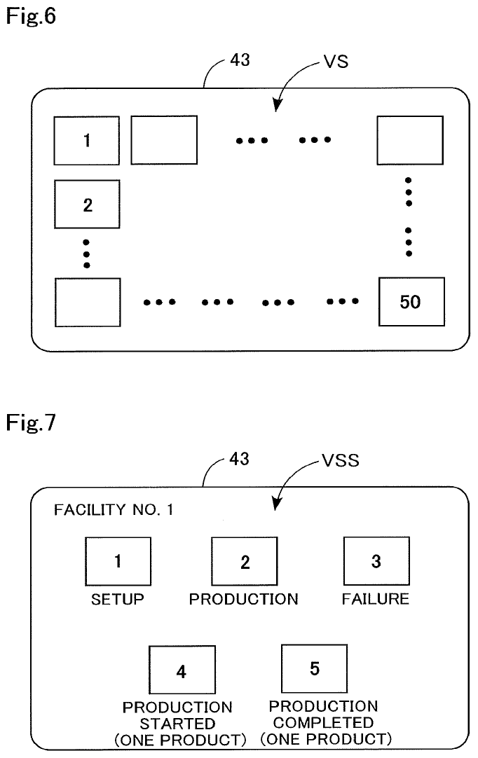

In contrast, when the operator visually recognizes that the indicator lamp Lon the facility M No. 1 is lit in red, the operator displays a facility selection screen VS on the mobile information display part 43 of the mobile terminal unit 4 as illustrated in FIG. 6. Icons of all the facilities M No. 1 to No. 50 are displayed on the facility selection screen VS. Then, the icon of the facility M No. 1 in the facility selection screen VS is touched to display a facility status selection screen VSS for the facility M No. 1 as illustrated in FIG. 7.

The facility status selection screen VSS displays “1” SETUP, “2” PRODUCTION, “3” FAILURE, “4” PRODUCTION STARTED (one product), and “5” PRODUCTION COMPLETED (one product). Then, the display of “3” FAILURE in the facility status selection screen VSS is touched. Accordingly, the mobile terminal unit 4 transmits a signal notifying that the facility M No. 1 has a failure to the facility status management apparatus 3 over the wireless.

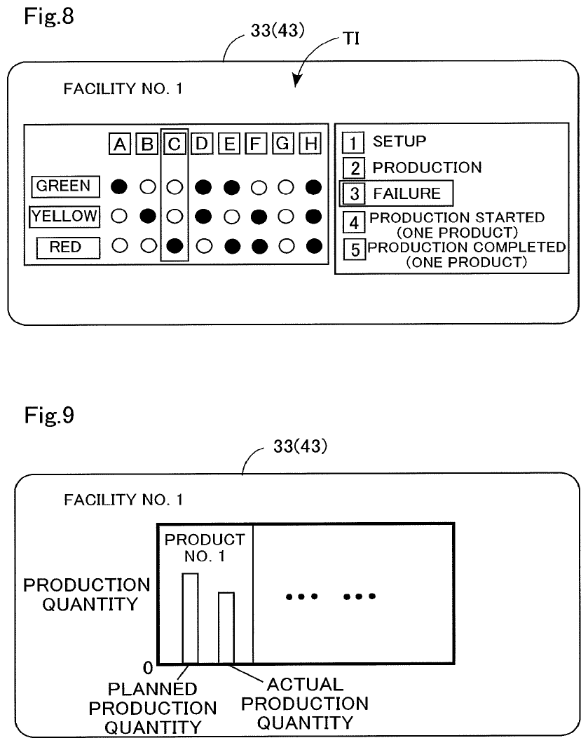

The facility status management apparatus 3 integrates information on the signal received from the communication unit 2 notifying that the indicator lamp L on the facility M No. 1 is lit in red and information on the signal received from the mobile terminal unit 4 notifying that the facility M No. 1 has a failure. Then, as illustrated in FIG. 8, integrated information TI is displayed on the management information display 33, and the integrated information TI is transmitted to the mobile communication part 41 to display the integrated information TI on the mobile information display 43.

In FIG. 8, “A to H” indicate patterns of green, yellow and red of the indicator lamp L on the facility M No. 1. Black circles indicate being lit and white circles indicate being lit out. The flickering pattern is omitted. Since the facility status management apparatus 3 receives the signal notifying that the indicator lamp L on the facility M No. 1 is lit in red (abnormal (failure)) from the communication unit 2, the corresponding “C” pattern is surrounded by a frame.

Since the facility status management apparatus 3 receives the signal notifying that the facility M No. 1 has a failure from the mobile terminal unit 4, the corresponding “3” FAILURE is boxed. Accordingly, the administrator can collate the sensed information on the communication unit 2 with the visual information (on the mobile terminal unit 4) from the operator, can reliably perceive the facility status of the facility M No. 1 and can instruct the correspondence to the operator.

A second display example is a display by which progress of production of the facility M can be confirmed by the facility status management apparatus 3 and the mobile information display 43 based on the facility status of the facility M sensed by the light sensing sensor units 25a, 25b and 25c in the communication unit 2. The second display example will be described below.

For example, when the production of one product having a product No. 1 is completed in the facility M No. 1 and the light sensing sensor unit 25c senses that the indicator lamp L flickers in green, the communication unit 2 of the facility M No. 1 transmits a signal notifying that the indicator lamp L on the facility M No. 1 flickers in green to the facility status management apparatus 3 over the wireless.

The facility status management apparatus 3 recognizes that production of one product of the product No. 1 is completed by the signal received from the communication unit 2 notifying that the indicator lamp L on the facility M No. 1 flickers in green. From then onward, the above processing is repeated to count the production quantity of the product No. 1. When planned production time stored in advance for the product No. 1 in the facility M No. 1 is reached, the production quantity of the product No. 1 at that time is obtained as an actual production quantity.

As illustrated in FIG. 9, the facility status management apparatus 3 displays the planned production quantity and the actual production quantity during the planned production time of the product No. 1 described above on the management information display 33. The facility status management apparatus 3 may transmit the planned production quantity and the actual production quantity of the product No. 1 to the mobile communication part 41 to display the same on the mobile information display 43. Accordingly, the administrator and the operator can perceive a production delay.

Further, the facility status management apparatus 3 obtains a value calculated by dividing an integrated value of the planned production quantity of the product No. 1 and the machine cycle time of the product No. 1 by the planned production time of the product No. 1, that is, the planned operating rate of the product No. 1. Further, a value calculated by dividing an integrated value of the actual production quantity of the product No. 1 and the machine cycle time of the product No. 1 by the actual operating time of the product No. 1, that is, the actual operating rate of the product 1 is obtained.

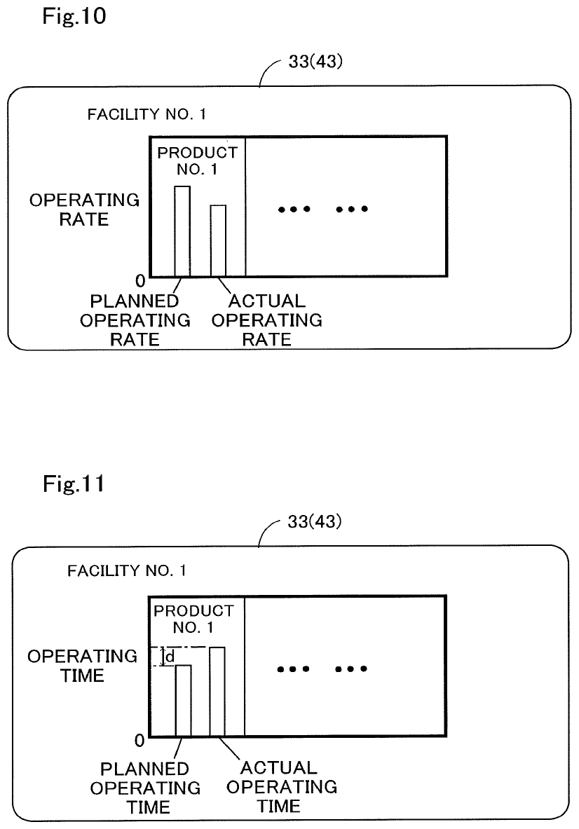

Subsequently, as illustrated in FIG. 10, the facility status management apparatus 3 displays the planned operating rate of the product No. 1 and the actual operating rate of the product No. 1 on the management information display 33. It should be noted that the planned operating rate of the product No. 1 and the actual operating rate of the product No. 1 may be transmitted to the mobile communication part 41 to be displayed on the mobile information display 43. Accordingly, the administrator and the operator can improve the production.

When the production time of the product No. 1 in the facility M No. 1 reaches a predetermined period of time (actual operating time), the facility status management apparatus 3 obtains the production quantity of the product No. 1 at that time. Then, the planned operating time is obtained based on the obtained production quantity of the product No. 1 and the machine cycle time of the product No. 1.

Subsequently, as illustrated in FIG. 11, the facility status management apparatus 3 displays the planned operating time of the product No. 1 and the actual operating time of the product No. 1 on the management information display 33. It should be noted that the planned operating time of the product No. 1 and the actual operating time of the product No. 1 may be transmitted to the mobile communication part 41 to be displayed on the mobile information display 43. Accordingly, the administrator and the operator can directly perceive the production delay of the product No. 1 from a difference d between the actual operating time and the planned operating time.

The management information display 33 and the mobile information display 43 also display the light sensing signals of the light sensing sensor units 25a, 25b and 25c, a lighting duration time of the indicator lamp L, the time of the day when the indicator lamp L is changed from a state of being lit-out to the state of being lit, an internal temperature of the communication unit 2, an ID of the facility M, a battery residual amount of the detection power source unit 23, and a radio wave intensity of the wireless module 22a. When the battery residual amount of the detection power source unit 23 and the radio wave intensity of the wireless module 22a are lowered, a warning or the like is displayed together.

### 4. Others

In the above-described embodiment, the light sensing sensor units 25a, 25b and 25c are digital sensors configured to sense light fluxes or illuminance of light from the light sources 23a, 23b and 23c, but may also be digital sensors configured to sense colors of red, yellow and green light transmitted through the plastic cases La, Lb and Lc. The indicator lamp L of the communication unit 2 is not limited to the light sources of three colors, and light sources of a given number of colors or a single light source capable of changing the color of light to be emitted are also applicable.

What is claimed is:

1. A facility management system comprising:
a communication unit including a main body part disposed on an indicator lamp capable of displaying a facility status, a communication unit terminal attachable/detachable to/from a terminal in a sensor unit, and a communication processing part capable of being communicably connected with a sensor in the sensor unit and capable of communicating a sensing signal from the sensor over the wireless; and
a facility status management apparatus including a management communication part capable of communicating with the communication processing part over the wireless and a management information display displaying information on a sensing signal from the sensor communicating via the management communication part, wherein
the sensor unit includes a light sensing sensor unit including a light sensing sensor configured to sense light from the indicator lamp and a first light sensing sensor terminal connected with the light sensing sensor,
the sensor unit also includes a facility item sensing sensor unit including a facility item sensing sensor configured to sense items relating to the facility and a facility item sensing sensor terminal connected with the facility item sensing sensor, and
the communication unit terminal is attachable/detachable to/from the first light sensing sensor terminal and is attachable/detachable to/from the facility item sensing sensor terminal.

2. The facility management system according to claim 1, wherein the facility item sensing sensor transmits a sensed facility item sensing signal indicating on and off to the communication processing part via the communication unit terminal connectable with the facility item sensing sensor terminal by a serial bus.

3. The facility management system according to claim 1, wherein the facility item sensing sensor transmits a sensed facility item sensing signal indicating other than on and off to the communication processing part via the communication unit terminal connectable with the facility item sensing sensor terminal by a serial bus.

4. The facility management system according to claim 1, wherein the facility item sensing sensor unit comprises:
a power supply unit supplying a drive current supplied from a power source of the facility to the facility item sensing sensor and the communication processing part; and
a serial converter converting the facility item sensing signal of the facility item sensing sensor to allow serial communication.

5. The facility management system according to claim 1, wherein the communication unit comprises the communication unit terminal capable of establishing a communication connection between the light sensing sensor and the facility item sensing sensor in an alternative way.

6. The facility management system according to claim 1, wherein the communication unit comprises a plurality of the communication unit terminals capable of establishing a communication connection between a plurality of the light sensing sensors and the facility item sensing sensor.

7. The facility management system according to claim 1, wherein the communication unit transmits a sensor connection status confirmation signal via the communication processing part and, if no signal is returned, determines that the light sensing sensor and the facility item sensing sensor are not connected, and if a light sensing sensor connection signal is returned, determines that the light sensing sensor is connected, and if a facility item sensing sensor connection signal is returned, determines that the facility item sensing sensor is connected.

8. The facility management system according to claim 1, further comprising:
a mobile terminal unit including: a mobile communication part capable of communicating with the communication processing part of the communication unit and the management communication part of the facility status management apparatus over the wireless, and a mobile information display displaying information to be communicated via the mobile communication part, wherein
the management communication part of the facility status management apparatus integrates information on a light sensing signal sensed by the light sensing sensor received from the communication processing part via the management communication part and information received from the mobile communication part via the management communication part, and displays the same on the management information display as integrated information.

9. The facility management system according to claim 8, wherein the facility status management apparatus transmits the integrated information from the management communication part to the mobile communication part and displays the integrated information on the mobile information display.

10. The facility management system according to claim 8, wherein the mobile communication part transmits information on a signal indicating an actual facility status.

11. The facility management system according to claim 8, wherein
the facility status management apparatus
obtains an actual performance of facility based on the information on the signal received from the communication unit via the management communication part and relating to the light sensing sensor to display the obtained actual performance and a plan corresponding to the facility stored in advance on the management information display,
transmits the actual performance of the facility and the plan corresponding to the facility from the management communication part to the mobile communication part and displays the actual performance of the facility and the plan corresponding to the facility on the mobile information display.

12. The facility management system according to claim 1 wherein the facility status management apparatus obtains an actual performance of the facility based on the information on the signal received from the communication unit via the management communication part and relating to the light sensing sensor, displays the obtained actual performance and a plan corresponding to the facility stored in advance on the management information display.

13. The facility management system according to claim 11, wherein the facility status management apparatus displays at least one of a production quantity, an operating time, and an operating rate as the actual performance of the facility on the management information display.
